(19) United States
(12) Patent Application Publication
(10) Pub. No.: US 2003/0175437 A1
(43) Pub. Date: Sep. 18, 2003

(54) Coating film forming method

(76) Inventors: Masuji Tsuda, Yokohama-shi (JP); Mitsugu Endoh, Ashigarakami-gun (JP); Yoshiyuki Yukawa, Hiratsuka-shi (JP)

Correspondence Address: HUNTLEY & ASSOCIATES, 1105 NORTH MARKET STREET, P.O. BOX 948, WILMINGTON, DE, 19899-0948, US

(21) Appl. No.: 10/387,742

(22) Filed: Mar. 13, 2003

(30) Foreign Application Priority Data
Mar. 13, 2002 (JP) 68336/2002
Feb. 6, 2003 (JP) 29462/2003

(51) Int. Cl. B05D 3/02; B05D 1/36

(52) U.S. Cl. 427/385.5; 427/256; 427/407.1

(57) ABSTRACT

In a coating film forming method in which the thermosetting water-borne color paint (A) is coated on the surface of the substrate, then a thermosetting water-borne paint containing color pigment and/or glittering pigment (B) is coated on said coated surf ace, and, after preheating as necessary, a thermosetting clear paint (C) is coated and after that said 3-layer coating films of (A), (B) and (C) are simultaneously cured by heating, an accelerator to thicken is atomized on the coated surface of a thermosetting water-borne color paint (A), when said paint is coated or after said paint is coated.

The coating film forming method of this invention is 3-coat-1-bake system using an aqueous coating composition, and is possible to control the viscosity of the wet coat of the water-borne paint as the first basecoat without predrying after coating, and to form a coating film having superior aesthetic appearance.

### BACKGROUND OF THE INVENTION

1. Field of the Invention

This invention relates to a coating film forming method which is 3-coat-1-bake system using an aqueous coating composition and is possible to control the viscosity of the wet coat of the water-borne paint as the first basecoat without predrying after coating, and to form a coating film having superior aesthetic appearance.

2. Description of the Prior Art

A 2-coat-1-bake system or 3-coat-1-bake system is adopted conventionally in a top coating film-forming method for bodies of automobiles and the like. In late years a water-borne paint is adopted as base coating from point of environmental protection. In this case, a predrying (preheating) process is required before next coating process, in order to form a coating film having good appearance.

When the 3-coat system is conducted particularly with using a water-borne paint as both of the first basecoat and the second basecoat in 3-coat-1-bake system, 2 degrees of predrying process becomes necessary. In industrial coating line, a space of the line is lengthened as necessary, so it is demanded that the predrying process is reduced in the coating line from point of the reduction of the manufacture cost and energy.

However, when the second basecoat water-borne paint was applied without the predrying process after the first basecoat water-borne paint was applied, there was a problem that mixing of the two layers occurred at the interface between the two coated layers, and the finished appearance of the formed coating film deteriorated due to sagging (particularly at vertical surface), face roughening and after-tack of the coating film. On the other hand, in order to apply the second basecoat water-borne paint and then apply a clear paint on said coated surface, it was necessary to decrease enough a content rate of water included in the two-coated layers. It was difficult that the predrying process was reduced from point of appearance and physical property of coated film.

### SUMMARY OF THE INVENTION

An object of the present invention is to provide a coating film forming method, which is 3-coat-1-bake formula using an aqueous coating composition and is possible to control the viscosity of the wet coat of the water-borne paint as the first basecoat without predrying after coating, and to form a coating film having superior aesthetic appearance.

The present invention provides a coating film forming method characterized by spraying an accelerator to thicken on the coated surface of a thermosetting water-borne color paint (A), when said paint is coated or after said paint is coated, in a coating film forming method in which the thermosetting water-borne color paint (A) is coated on the surface of the substrate, then a thermosetting water-borne paint containing color pigment and/or glittering pigment (B) is coated on said coated surface, and, after preheating as necessary, a thermosetting clear paint (C) is coated and after that said 3-layer coating films of (A), (B) and (C) are simultaneously cured by heating.

### DETAILED DESCRIPTION OF THE INVENTION

The thermosetting water-borne color paint (A) used in the present invention contains color pigment, and glittering pigment as necessary, water as main solvent and contains water-soluble or water dispersible thermosetting resin.

As a water-soluble or water-dispersible thermosetting resin there can be used, for example, acrylic resin, polyester resin, polyurethane resin, graft polymer of these resins and further self-cross linking resins such as polyester resin etc. containing blocked isocyanate groups. Particularly, acrylic resin, polyester resin, or polyurethane resin having acid value of 5-100 mgKOH/g and hydroxyl value of 20-200 mgKOH/g are preferred.

As an acrylic resin mentioned above there can be mentioned copolymer, made by copolymerizing a mixture consisting of carboxyl group-containing unsaturated monomer, hydroxyl group-containing unsaturated monomer, and other unsaturated monomers, with number-average molecular weight of 3,000-100,000 preferably 5,000 to 50,000.

As a carboxyl group-containing unsaturated monomer there can be mentioned, for example, (meth)acrylic acid, crotonic acid, maleic acid, fumaric acid, itaconic acid and halfmonoalkyl-esterified compounds of dicarboxylic acids out of them and as a hydroxyl group-containing unsaturated monomer there can be mentioned, for example, hydroxyalkyl esters of acrylic acid or methacrylic acid such as hydroxyethyl (meth)acrylate, hydroxypropyl (meth) acrylate, hydroxybutyl (meth)acrylate etc. A kind or more than two kinds of them can be used.

As another unsaturated monomer there can be mentioned, for example, alkyl esters or cycloalkyl esters of a carbon number of 1-24 of acrylic acid or methacrylic acid such as methyl (meth) acrylate, ethyl (meth)acrylate, n-, i-propyl(meth)acrylate, n-, i-, t-butyl(meth)acrylate, 2-ethylhexyl(meth)acrylate, cyclohexyl(meth)acrylate, lauryl(meth)acrylate, isobornyl(meth)acrylate etc.; glycidyl(meth)acrylate, acrylonitrile, acrylamide, dimethylaminoethyl methacrylate, styrene, vinyltoluene, vinyl acetate, vinyl chloride etc. A kind or more than two kinds of them can be used.

As the polymerization method of the mixture of unsaturated monomers, emulsion polymerization, solution polymerization, and the like can be used.

The acrylic copolymer obtained by emulsion polymerization comprises an aqueous dispersion of emulsified polymer particles generally having a multilayer construction prepared by copolymerizing the mixture of unsaturated monomers to multistage emulsion polymerization in the presence of water and an emulsifier.

Neutralization of carboxyl groups in the acrylic copolymer can be conducted, as necessary, by using a basic substance and preferably before mixing with a crosslinking agent etc.

A basic substance is preferably water-soluble and there can be mentioned, for example, ammonia, methylamine, ethylamine, propylamine, butylamine, dimethylamine, trimethylamine, triethylamine, ethylenediamine, morpholine, methylethanolamine, dimethylethanolamine, diethanolamine, triethanol amine, diisopropanolamine, 2-amino-2-methylpropanol etc. A kind or more than two kinds of them can be used.

A polyester resin is an oil-free or oil-modified polyester resin prepared by esterification using polyhydric alcohol polybasic acid and further monbasic acid, oil component (including its fatty acid) etc. as necessary. Number-average molecular weight of the resin is suitable in the range of about 500-50000, preferably 3000-30000.

As a polyhydric alcohol there can be mentioned, for example, ethylene glycol, diethylene glycol, propylene glycol, butanediol, pentanediol, hexanediol, 2,2-dimethylpropanediol, glycerol, trimethylolpropane, pentaerythritol, Cardura E (made by Shell Chemicals Japan Ltd., trade name) etc. A kind or more than two kinds of them can be used. As a polybasic acid there can be mentioned, for example, phthalic acid, isophthalic acid, tetrahydrophthalic acid, hexahydrophthalic acid, maleic acid, succinic acid, adipic acid, sebacic acid, trimellitic acid, pyromellitic acid and their anhydrides etc. A kind or more than two kinds of them can be used. A monobasic acid there can be mentioned, for example, benzoic acid, t-butylbenzoic acid etc. and as oil component there can be mentioned, for example, castor oil, dehydrated castor oil, safflower oil, soybean oil, rinseed oil, tall oil, coconut oil and is their fatty acids etc. A kind or more than two kinds of them can be used.

In a polyester resin a carboxyl group can be introduced, for example, by using a polybasic acid having more than 3 carboxyl groups in the molecule such as trimellitic acid, pyromellitic acid etc. together, or by half-esterification of dicarboxylic acid, and a hydroxyl group can be introduced easily by using a polyhydric alcohol having more than 3 hydroxyl groups in the molecule such as glycerol, trimethylolpropane etc. together.

Neutralization of carboxyl groups in the polyester resin can be conducted by using the above-mentioned basic substance and preferably before mixing with a crosslinking agent etc.

The urethane resin is preferably an aqueous dispersion by the following method. First a urethane prepolymer is synthesized by subjecting to a one-shot or multi-stage polymerization (optionally in a hydrophilic organic solvent free of active hydrogen in the molecule): an aliphatic and/or alicyclic diisocyanate, a polyether diol or polyester diol both having a number-average molecular weight of about 500 to about 5000 or a mixture thereof, a low-molecular weight polyhydroxyl compound and a dime thylol a lkanoi c acid in an NCO/OH equivalent ratio 1.1-1.9:1. The prepolymer thus obtained is mixed with water after or during neutralization of prepolymer with a tertiary amine, and the resulting mixture is subjected to reaction for chain extension by water while being emulsified and dispersed in water. Thereafter, when required, the organic solvent is distilled off.

The aliphatic and alicyclic diisocyanates used in production of said urethane prepolymer include aliphatic diisocyanates each having 2-12 carbon atoms, such as hexamethylene diisocyanate, 2,2,4trimethylhexane diisocyanate, lysine diisocyanate and the like; alicyclic diisocyanates each having 4-18 carbon atoms, such as 1,4-cyclohexane diisocyanate, 1-isocyanato-3-isocyanatomethyl-3,5,5 trimethylcyclohexane(isophorone diisocyanate, IPDI) 4,4′-dicyclohexylmethane diisocyanate, methylcyclohexylene diisocyanate, isopropylidenedicyclohexyl-4,4′-diisocyanate and the like; modification products of these diisocyanates (e.g. carbodiimide-, uretidion- or urethonimine containing modification products); and mixtures of two or more of the above.

The polyetherdiol and polyesterdiol having a number-average molecular weight of generally 5005,000, preferably 1,000-3,000, used in production of the urethane prepolymer include diols such as polyethylene glycol, polypropylene glycol, polyethylene-propylene (block or random) glycol, polytetramethylene ether glycol, polyhexamethylene ether glycol, polyoctamethylene ether glycol and the like;

polyethylene adipate, polybutylene adipate, polyhexamethylene adipate, polyneopentyl adipate, poly-3-methylpentyl adipate, polyethylene/butylenes adipate, polyneopentyl/hexyl adipate and the like; polycaprolactonediol, poly-3 methylvalerolactonediol and the like; polycarbonatediols; and combinations of two or more of the above.

The low-molecular weight polyhydroxyl compound used in production of the prepolymer is preferably those-having a number-average molecular weight of less than 500 and includes, for example, the glycols mentioned above with respect to the raw materials for polyesterdiol, and alkylene oxide adducts thereof (both the glycols and the adducts have a molecular weight of less than 500); trihydric alcohols (e.g. glycerine, trimethylol ethane and trime thylolpropane) and alkylene oxide adducts thereof (both the alcohols and the adducts have a molecular weight of less than 500);

and mixtures of two or more of the above. The low-molecular weight polyhydroxyl compound can be used in an amount of generally 0.1-20% by weight, preferably 0.5-10% by weight based on the total amount of the polyetherdiol and the polyesterdiol.

The dimethylolalkanoic acid used in production of the urethane prepolymer includes, for example, dimethylolacetic acid, dimethylolpropionic acid and dimethylolbutyric acid; and mixtures of two or more of the above. The amount of the dimethylolalkanoic acid used can be generally 0.5-5% by weight, preferably 1-3% by weight in terms of the amount of carboxyl group present in the urethane prepolymer.

The tertiary amine used for neutralization of the urethane prepolymer can be mentioned, for example, trimethylamine, triethylamine, triisopropylamine, tri-n-propylamine, tri-n-buthylamine; methylmorpholine, N-ethylmorpholine; N-dimethylethanolamine, N-diethylethanolamine, etc. A kind or more than two kinds of them can be used.

A crosslinking agent can be used to crosslink and cure the above-mentioned water-soluble or water dispersible thermosetting resins. The crosslinking agent, for example, a blocked polyisocyanate, amino resin etc. can be preferably used. A melamine resin and a phenol-formaldehyde resin are suitable as the amino resin. These resins may be either water-soluble or hydrophobic.

Application ratio of a water-soluble or water-dispersible thermosetting resin and a crosslinking agent is appropriate, as solid content weight, in the range of 50-90% by weight, preferably 60-80% by weight of the former and 50-10% by weight, preferably 40-20% by weight of the latter.

Coating film with said thermosetting water-borne color paint (A) may be made non-transparent solid tone or metallic tone by compounding color pigment or glittering pigment. As a color pigment there can be mentioned, for example, inorganic and organic color pigments such as titanium dioxide, carbon black, iron oxide red, phthalocyanine pigment, quinacridone pigment etc. and as a glittering pigment, for example, aluminum flake aiming at improving hiding power, and for example, mica, mica-like iron oxide etc. aiming at designability. A kind or more than two kinds of them can be used. By compounding these pigments, hiding power of the coating film with the thermosetting water-borne color paint (A) is increased and an intermediate coating step may be omitted.

In the thermosetting water-borne color paint (A) there may be compounded, as necessary, additives for paint such as organic solvent, extender pigment, curing catalyst, leveling agent, pigment dispersing agent, viscosity controller, ultraviolet absorber, oxidation inhibitor etc.

As an organic solvent partly used in the thermosetting water-borne color paint (A) already known solvents can be used and there can be mentioned, for example, solvents of ester type, ketone type, ether type, alcohol type etc. A kind or more than two kinds of them can be used. Among them, it is preferable to use, particularly, a hydrophilic solvent, which dissolves more than 50 parts by weight in 100 parts by weight of water at 20° C.

The thermosetting water-borne paint (B) used in the present invention contains color pigment and/or glittering pigment, water as main solvent, contains water-soluble or water-dispersible thermosetting resin and is compounded, as necessary, with extender pigment, leveling agent, organic solvent curing catalyst, pigment dispersing agent, viscosity controller, ultraviolet absorber, oxidation inhibitor etc.

As a water-soluble or water-dispersible thermosetting resin there can be suitably selected from what were mentioned in the description of the above-mentioned thermosetting water-borne color paint (A) and used. As a cross linking agent used in combination with said resin there can be mentioned, for example, a blocked polyisocyanate, an amino resin etc.

As a color pigment there can be mentioned, for example, inorganic and organic color pigments such as titanium dioxide, carbon black, iron oxide red, phthalocyanine pigment, quinacridone pigment and as a glittering pigment there can be mentioned, for example, aluminum flake, mica, colored mica, mica-like iron oxide etc. A kind or more than two kinds of them can be used. The amount of said color pigment and glittering pigment to be used is appropriate in the range of 1-100 parts by weight to 100 parts by weight of the resin solid content.

The clear paint (C) used in the present invention is a thermosetting paint prepared by containing base resin, cross linking agent, organic solvent etc. and by compounding, as necessary, color pigment, ultraviolet absorber, light stabilizer etc. It has such a transparency that the metallic effect of the lower layer coating film is visually recognized through the clear coating film.

As said base resin there can be mentioned, for example, acrylic resin, polyester resin, alkyd resin, fluoro resin, urethane resin, silicon-containing resin etc. containing cross linkable functional group, for example, hydroxyl group, carboxyl group, silanol group, epoxy group etc. Particularly acrylic resin containing cross linkable functional group is preferable. As a cross linking agent there can be mentioned melamine resin, urea resin, (blocked) polyisocyanate compound, epoxy compound, carboxyl group-containing compound, acid anhydride, alkoxysilane group-containing compound etc. which can react with such functional groups. The application ratio of said base resin and cross linking agent is, appropriate, as solid content, in the range of 50-90% by weight, preferably 65-80% by weight of the former and 50-10% by weight, preferably 45-20% by weight of the latter.

The coating film forming method of the present invention is to coat the above-mentioned thermosetting water-borne color paint (A) on the surface of a substrate, to coat the above-mentioned thermosetting water-borne paint (B) on said coated surface, to predry as necessary, then to coat the above-mentioned thermosetting clear paint (C) and to cure said 3-layer coating films (A), (B) and (C) simultaneously by heating.

As the surface of a substrate to be coated with the above-mentioned thermosetting water-borne color paint (A) there can be mentioned, for example, surface of a material such as metal, plastics etc. and further a coated surface such as a surface of an outer panel of a car body, as necessary, prepared by coating and curing an undercoat such as electro deposition paint and intermediate coat.

Coating of the thermosetting water-borne color paint (A) is conducted by using rotary electrostatic coating, air spray (air spray nozzle), airless spray etc. Paint viscosity at the coating is preferably adjusted to Ford cup #4 about 10-60 seconds (20° C.) and the coating is conducted so that the coating film thickness would be about 2-30 μm as a cured coating film.

In the coating film forming method according to the present invention the accelerator to thicken is atomized on the coated surface of a thermosetting water-borne color paint (A), when said paint is coated or after said paint is coated. The said accelerator seeps in wet coat and raise the wet film viscosity, so suitable constituent as the said accelerator can be employed depending on constituent in paint (A) and include, for example, a tertiary amine etc.

The tertiary amine can be mentioned, for example, trimethylamine, triethylamine, triisopropylamine, dimethylethylamine, N-methylmorpholine, N-methylmorpholine, N-dimethylethanolamine, N-diethyl ethanolamine, etc. A kind or more than two kinds of them can be used.

Spraying of the accelerator to thicken is conducted by coating by means of an atomizing air which made contain steam or mist of said agent, making the steam of said accelerator come in contact with the wet coat of the paint (A), or spraying the mist of said agent.

In the case of using a tertiary amine as the accelerator to thicken, it is preferable that the amine of 2-8% by weight based on the weight of the wet coat permeate in said wet film of the paint (A) to obtain good viscosity rising effect.

Then the thermosetting water-borne paint (B) is coated on the surface of the coating film of said paint (A) resulting the wet film viscosity increased as described above. Coating of the thermosetting water-borne paint (B) is conducted by using rotary electrostatic coating, air spray (air spray nozzle), airless spray etc. The coating is conducted so that the coating film thickness would be about 2-30 μm as a cured coating film.

The predrying conducted after the coating of the above-mentioned thermosetting water-borne paint (B) is to heat at the predrying temperature of about 30-100° C. for about 2-5 minutes by hot air or infrared according to already known methods.

Coating with the clear paint (C) is conducted by using rotary electrostatic coating, air spray (air spray nozzle), airless spray etc. so that the coating film thickness be about 5-100 μm as cured coating film. After the coating with said clear paint (C), 3-layer coating films with paints (A)-(C) can be cured simultaneously by heating at 100-180° C. for 10-40 minutes.

The present invention is explained more fully in the following Examples and Comparative Examples, in which parts and percentages are all by weight.

Production of Acrylic Emulsion

### PRODUCTION EXAMPLE 1

In a reaction vessel, 140 parts of deionized water, 2.5 parts of 30% “Newcol 707SF” (surfactant made by Nippon Nyukazai Co., Ltd.) and 1 part of the monomer mixture (1) were mixed and stirred under nitrogen gas stream, heated to 60° C. and 3 parts of 3% aqueous solution of ammonium persulfate were added. After warming up to 80° C., a monomer emulsion consisting of 79 parts of the monomer mixture (1), 2.5 parts of “Newcol 707SF”, 4 parts of 3% aqueous solution of ammonium per sulfate and 42 parts of deionized water was added to the reaction vessel in 4 hours and matured for 1 hour.

Then 20.5 parts of the monomer mixture (2) and 4 parts of 3% aqueous solution of ammonium per sulfate were simultaneously added drop wise to the reaction vessel in 1.5 hours. The reaction mixture was then matured for 1 hour, diluted with 30 parts of deionized water, and then filtered through a 200-mesh nylon cloth at 30° C. An acrylic emulsion with 20% solid content and a particle diameter of 0.1 μm was obtained by addition of deionized water to the filtrate and adjusting its pH to 7.5 with dimethylaminoethanol.

The monomer mixture (1) contained 55 parts of methyl methacrylate, 8 parts of styrene, 9 parts of n-butyl acrylate, 5 parts of 2-hydroxyethyl acrylate, 2 parts of 1,6-hexanediol diacrylate and 1 part of methacrylic acid.

The monomer mixture (2) contained 5 parts of methyl methacrylate, 7 parts of n-butyl acrylate, 5 parts of 2-ethylhexyl acrylate, 3 parts of methacrylic acid and 0.5 parts of “Newcol 707SF”.

Production of Urethane Emulsion

### PRODUCTION EXAMPLE 2

In a reaction vessel, 115.5 parts of a polybutylene adipate having a number-average molecular weight of 2,000, 115.5 parts of a polycaprolactonediol having a number-average molecular weight of 2,000, 23.2 parts of dime thylolpropi oni c acid, 6.5 parts of 1, 4-butanediol and 120.1 parts of 1-isocyanato-3 isocyanatomethyl-3,5,5-trimethylcyclohexane (IPDI) were added. The mixture was stirred in a nitrogen gas atmosphere at 85° C. for 7 hours to give rise to a reaction to obtain an NCO-terminated prepolymer having an NCO content of 4.0%.

The prepolymer was cooled to 50° C. Thereto was added 165 parts of acetone, followed by stirring to obtain a uniform solution. Thereto was added 15.7 parts of triethylamine with stirring. To the mixture being stirred and kept at 50° C. or below was added 600 parts of deionized water. The resulting aqueous dispersion was kept at 50° C. for 2 hours to complete a reaction for chain extension by water. The resulting dispersion was subjected to distillation at 70° C. or below under reduced pressure to remove acetone, whereby a urethane resin emulsion with 42% solid content was obtained.

Production of Cross Linking Agent

### PRODUCTION EXAMPLE 3

In a vessel was placed 41.7 parts of a hydrophobic melamine resin (“U-Van 28SE” manufactured by Mitsui Chemicals, Inc., 60% solid content, solvent dilution=0.4). Thereto was added 20 parts of the aqueous acrylic resin solution(note 1). They were stirred at 1,000-1,500 rpm by the use of disperser. Thereto was gradually added 80 parts of deionized water. Stirring was continued for a further 30 minutes to obtain a cross linking agent of aqueous dispersion form having 20% solid content and an average particle diameter of 0.11 μm.

(Note 1) Into a reactor were fed 60 parts of butyl cellosolve and 15 parts of isobutyl alcohol. They were heated to 115° C. in a nitrogen current. Then, thereto was added, in 3 hours, a mixture consisting of 26 parts of n-butyl acrylate, 47 parts of methyl methacrylate, 10 parts of styrene, 10 parts of 2-hydroxyethyl methacrylate, 6 parts of acrylic acid and 1 part of azoisobutyronitrile. After the addition, the mixture was aged at 115° C. for 30 minutes. Thereto was added, in 1 hour, a mixture consisting of 1 part of azobisisobutyronitrile and 115 parts of butyl cellosolve. The mixture was aged for 30 minutes and then filtered through a 200-mesh nylon cloth at 50° C. The resulting reaction product had an acid value of 48, a viscosity of Z4 as measured by a Gardner-Holdt bubble viscometer and 55% solid content. It was neutralized with an equivalent amount of dimethylaminoethanol and then mixed with deionized water, to obtain a 50% aqueous acrylic resin solution.

Preparation of Thermosetting Water-Borne Color Paint (A)

325 parts of the acrylic emulsion with 20% solid content prepared by production example 1, 35.7 parts of the urethane resin emulsion with 42% solid content prepared by production example 2, and 100 parts of the cross linking agent dispersion with 20% solid content prepared by production example 3 were mixed and then 99.98 parts of Titanium White and 2 parts of carbon black were added thereto and dispersed. A thermosetting water-borne color paint (A) was obtained by adjusting the dispersion and deionized water to 20% solid content.

Preparation of Thermosetting Water-Borne Paint (B)

325 parts of the acrylic emulsion with 20% solid content prepared by production example 1, 35.7 parts of the urethane resin emulsion with 42% solid content prepared by production example 2, and 100 parts of the cross linking agent dispersion with 20% solid content prepared by production example 3 were mixed and then 20 parts of “Aluminium Paste 891 K” (made by Toyo Aluminium Co., Ltd.) were added and dispersed. A thermosetting water-borne metallic paint (B) was obtained by adjusting the dispersion with deionized water to 25% solid content.

Preparation of Clear Paint (C)

A mixture consisting of 57 parts of an acrylic resin solution (Note 2), 50 parts of a non-aqueous acrylic resin dispersion (Note 3), 30 parts of “Cymel 30311 (monomeric melamine resin made by Mitsui Chemicals Inc., 4 parts of 25% dodecylbenzenesulfonic acid solution and 0.5 parts of “BYK-30011 (leveling agent made by BYK-CHEMIE Co.) was adjusted to viscosity of 30 seconds (Ford cup #4, 20° C.) with “Swasol #100011 (aromatic hydrocarbon type solvent made by Cosmo Oil Co., Ltd.) to obtain a clear paint (C) with 55% solid content.

(Note 2) 40 parts of “Swasol #1000” were placed in a reaction vessel and heated to 120 V. A monomer mixture consisting of 30 parts of styrene, 35 parts of butyl acrylate, 10 parts of 2 ethylhexyl acrylate, 25 parts of hydroxyethyl acrylate and 4 parts of α,α′-azobisisobutyronitrile was added thereto for 3 hours and polymerized to obtain an acrylic resin solution (70% solid content) with hydroxyl value of 120 and number-average molecular weight of 6000.

(Note 3) 58 parts of “U-Van 28-60” (60% melamine resin solution made by Mitsui Chemicals Inc.), 30 parts of n-heptane and 0.15 parts of benzoyl peroxide were placed in a reaction vessel and heated to 95° C. Then a mixture consisting of 15 parts of styrene, 9 parts of acrylonitrile, 13 parts of methyl methacrylate, 15 parts of methyl acrylate, 1.8 parts of butyl acrylate, 10 parts of hydroxyethyl methacrylate, 1.2 parts of acrylic acid, 0.5 parts of benzoyl peroxide, 5 parts of n-butanoL 30 parts of “Shellsol 140” (made by Shell Chemicals Japan Ltd.) and 9 parts of n-heptane was added thereto dropwise in 3 hours. After maturation for 1 hour, 0.65 parts of t-butyl peroctoate and 3.5 parts of “Shellsol 14 0 11 were added thereto drop wise in 1 hour. After stirring at 95° C. for 2 hours the solvent was removed under reduced pressure to obtain a non-aqueous acrylic resin dispersion with solid content of 60% of and varnish viscosity A (Gardner-Holdt bubble viscosity).

Coating

### EXAMPLE I

A steel plate, which had been degreased and treated with zinc phosphate, was coated by electrodeposition with “Elecron #9400” (cationic electrodeposition paint made by Kansai Paint Co., Ltd. trade name) by a usual method to 20 p m of dry film thickness and cured by heating at 175 V for 30 minutes to obtain the substrate.

The above-mentioned substrates was coated with the paint (A) prepared as mentioned above by the use of a m-bell type rotary static electrocoating machine under the conditions of 200 cc/mm of paint delivery, 30000 rpm of number of rotation, 2 kg/cm2 of shaping air pressure, 30 cm of gun distance, 20° C. of booth temperature and 75% of booth humidity, to 20 μm of dry film thickness (as cured).

Spraying of the accelerator to thicken is conducted by spraying dimethylethanolamine atomized by using air spray gun (a diameter of 1.5 mm) at 1 stroke to the wet coat of the paint (A) under the condition of 50 cm of gun distance.

The resulting plate was allowed to stand in the booth for 2 minutes. Then, on the plate was coated, in two stages, the paint (B) prepared as mentioned above by the use of a m-bell type rotary static electrocoating machine under the conditions of 180 cc/mm of paint delivery, 2 kg/cm 2 of shaping air pressure, 30 cm of gun distance, 20° C. of booth temperature and 75% of booth humidity, to 7-8 p m of dry film thickness (as cured) in each stage and 15 μm in total. The resulting plate was allowed to stand in the booth for 3 minutes and then preheated at 80° C. for 10 minutes. Then, the clear paint (C) prepared as mentioned above was coated by the use of a minibell type rotary static electrocoating machine under the conditions of 300 cc/mm of paint delivery, 30000 rpm of number of rotation, 1.5 kg/cm 2 of shaping air pressure, 30 cm of gun distance, 20 V of booth temperature and 75% of booth humidity, to 45 μm of dry film thickness (as cured). The resulting plate was allowed to stand in a room for 7 minutes and then heated at 140° C. for 30 minutes to subject the films simultaneously to crosslinking and curing.

### COMPARATIVE EXAMPLE 1

Coated plate was obtained by following the procedure of Example 1, except that spraying dimethylethanolamine is not conducted after coating the paint (A).

Performance Test

The viscosity (mPa·s) of the wet coat after 1 minute from the coating with the paint (A) in each example and comparative example was measured and IV value of the obtained coated plate was evaluated.

Results are shown in Table 1 together.

(*1) IV value: Measured by using “Alcope” (made by Kansai Paint Co., Ltd.). The bigger the value is, the better the orientation of aluminum is meant.

TABLE 1
Example Comparative

| | | Comparative |
|---|---|---|
| | Example | Example |
| | 1 | 1 |
| Viscosity of the wet coat (mPa · s) | 75776 | 38912 |
| IV value | 239 | 167 |

According to the method of the present invention, in a coating film forming method using a water-borne paint as both of the first basecoat and the second basecoat it is possible to control the viscosity of the wet coat of the water-borne paint as the first basecoat without predrying after coating, and to form a coating film having superior aesthetic appearance.

We claim:

1. A coating film forming method characterized by spraying an accelerator to thicken on the coated surface of a thermosetting water-borne color paint (A) when said paint is coated or after said paint is coated, in a coating film forming method in which the thermosetting water-borne color paint (A) is coated on the surface of the substrate, then a thermosetting water-borne paint containing color pigment and/or glittering pigment (B) is coated on said coated surface, and, after preheating as necessary, a thermosetting clear paint (C) is coated and after that said 3-layer coating films of (A), (B) and (C) are simultaneously cured by heating.

2. A coating film forming method of claim 1 wherein the accelerator to thicken is a tertiary amine.

3. An article coated by the method of claim 1.
